(19) United States
(12) Patent Application Publication
(10) Pub. No.: US 2023/0325263 A1
(43) Pub. Date: Oct. 12, 2023

(54) User Interface Distribution Method for Multi-Device Interaction

(71) Applicant: Korea Advanced Institute of Science & Technology, DAEJEON (KR)

(72) Inventors: IN-SIK SHIN, SEOUL (KR); SANG-EUN OH, SUWON (KR); A-HYEON KIM, DAEJEON (KR); SUN-JAE LEE, DAEJEON (KR); YONG-MIN KO, Coquitlam (CA)

(21) Appl. No.: 17/718,678

(22) Filed: Apr. 12, 2022

(51) Int. Cl. G06F 9/54; G06F 9/451

(52) U.S. Cl. CPC G06F 9/547; G06F 9/451

(57) ABSTRACT

The present invention relates to user interface distribution method for multi-device interaction, and more particularly, to use the screens of a plurality of smart devices as user interfaces in flexible and fast manner without modifying the code of the application running in these devices. According to the present invention, by separating a subtree including target UI objects of a host device and moving it to a guest device, the target UI objects can be rendered on the guest device without modifying the application. In addition, since the interaction between the UI objects of the guest device and a host application logic is made in the form of a local function call, it is possible to transparently convert the local function call within the device into an RPC call between devices, also provides a way to maintain interaction between devices without modifying the application.

### CROSS-REFERENCE TO RELATED APPLICATIONS

This application is a Continuation Application (Bypass Continuation Application) being filed in the United States under 35 U.S.C. 111(a) that claims the benefit of and claims priority to, under 35 USC 120 and under 35 USC 365(c), the following: PCT Application PCT/KR2020/014187 having an International Filing Date of 16 Oct. 2020, and a Korean Patent Application No. 10-2019-0128772 having Korean Filing Date of 16 Oct. 2019. Both PCT Application PCT/KR2020/014187 and Korean Patent Application 10-2019-0128772 are incorporated by reference in their entirety herein, and the applicant claims the benefit of and claims priory to herein to both of these applications and the earliest priority date of 16 Oct. 2019.

### BACKGROUND OF THE INVENTION

### Field of the invention

The present invention relates to a method of and device configured for distributing a user interface for multi-device interaction, and more particularly, using the screens of a plurality of smart devices as a user interface in a flexible and fast manner without modifying the source code of the application used in the device.

### Related Art

FIG. 1 is a diagram illustrating a situation in which a user interface (UI) for chatting with other viewers and a broadcast video screen overlap while a user is watching a live broadcast through a live streaming app on a mobile device.

As shown in FIG. 1, various situations in which the user's main video screen and the UI screen overlap each other causes great inconvenience to users who want to enjoy the main video as a full screen. In addition, there was a need to distribute the app and the UI for it across multiple devices.

In order to solve this problem, in Paper 1 (UIWear: Easily Adapting User Interfaces for Wearable Devices, MobiCom 2017), a development tool that automatically creates a smartwatch app using some UIs of the mobile app is presented. However, in the Paper 1, there is a limitation that only the UIs determined in the development can be used in the smart watch. However, in the Paper 1, modifications to existing mobile apps are required, and customized UIs have limitations that cannot be properly supported.

In addition, in Paper 2 (CollaDroid: Automatic Augmentation of Android Application with Lightweight Interactive Collaboration, CSCW 2017) described below, a development tool that can modify existing apps to move UIs of mobile apps to other devices was presented. However, the Paper 2 also requires modifications to the existing mobile app, and there is a limitation that custom UIs cannot be properly supported.

### SUMMARY OF THE INVENTION

The present invention is invented to solve such a problem, by separating a subtree including a target UI object set of a host device and transmitting it to a guest device, it performs that the target UI object set is rendered in a guest device, and interactions between distributed devices are maintained without modifying the code of a app since local function calls between the distributed devices transparently are converted to RPC due to a interaction between UI object set and host app logic performed in the form of a local function call in a distributed device.

In order to achieve such a goal, when a first smart device (hereinafter referred to as “a host device”) according to the present invention executes a specific application, a program that serves as a platform of the host device (hereinafter referred to as “host platform”), a method for distributing a user interface (UI) to a second smart device (hereinafter referred to as “a guest device”) is performed by the operation of (a) displaying a list of devices that are proximately located and that can be used as guest devices and a list of applications (hereinafter referred to as “interaction applications”) on the host device screen that can interact using multiple UI screens of other devices; (b) transmitting a package file of a selected application selected according to a user's input to a selected device (hereinafter referred to as a “guest device”); and, (c) during operation of one of the applications (hereinafter referred to as a “host app”) in step (b), a UI object used by the host app is transmitted to the guest device selected in step (b).

Prior to the step (a), (a0) a static code analysis in which candidates of UI objects used by the application are extracted and stored from the code of the interaction application installed in the host device. The step of performing the static code analysis may be the entire application code, and the output of the static code analysis may be candidates of UI objects and UI resources used by the corresponding application.

The step (c) includes: (c11) receiving a user's input for selecting a UI element set transmitted to a guest device from among UIs used by the host app during operation of the host app; (c12) extracting a UI object set, from the candidates of UI objects extracted in step (a0), actually used in the guest device to execute the set of UI element selected in step (c11); (c13) transmitting the UI object extracted in step (c12) to the guest device; and (c14) storing the selected UI element set in step (c11) to the platform layout file of the host platform.

The step (c) includes: (c21) parsing a layout file of a corresponding a host app or a host platform (hereinafter collectively referred to as a “layout file”) during operation of the host app; (c22) extracting a UI object set specified in the layout file; and (c23) transmitting the UI object set extracted in step (c22) to the guest device.

In step (c), mirroring in which the entire screen including the UI object set is sent to the guest device may be performed.

The host device and the guest device may use the same platform as a base platform, or, when different base platforms are used, the host app may be an app using a platform-independent code.

The information transmitted to the guest device selected in step (c) may further include information on whether to migrate or replicate the UI to the guest device according to the user's selection, when it is selected as replication, after the step (c), (d) rendering the selected UI and displaying it on the screen of the host device may be further included.

When it is selected as replication or migration, after step (c), update of a UI state (hereinafter, the update of the UI state is referred to as a “UI update”) displayed on the screen of the host device. When the host app calls a local function for, (e) the function call is intercepted while the host app does not recognize it, and cross-device function calls (hereinafter referred to as “RPC (remote procedure call)”) and transmitting the message to the guest device.

When selected as replication, when a function call of the host app for the UI update is generated by a user input from the guest device, before the step (e), (e01) from the guest device, it may further include receiving data by the user input through the UI and displaying it on the screen of the host device.

When selected as replication, when the function call of the host app for the UI update is caused by a user input from the host device, before step (e), (e02) through the UI of the host device, it may further include receiving data by the user input.

When it is selected as replication, (g) performing a UI update in the host device may be further included.

When it is selected as replication, (h1) when receiving user input from the guest device, displaying it through a UI of the host device screen may be further included.

In the case of selection as replication, (h21) displaying data by the user input through the UI of the host device screen when receiving the data; and (h22) transmitting the input by the user input to the guest device.

The step (e) includes the steps of: (e1) calling a code conversion function which is set in advance to replace the function is called; (e12) converting the function into an RPC message by the code conversion function; and (e13) transmitting the RPC message to the guest device.

After the step (e), (f1) storing a return address to be returned after performing the RPC call; (f2) receiving a return value or an error code for the RPC call from the guest device; and, (f3) returning to the return address and performing the next step.

When selected as migration, (i) when an RPC message for calling a host app function is received from the guest device, the step of calling a function corresponding host app may be further included.

When an argument of the RPC message is a reference type argument, a data value indicated by the reference type factor may be transmitted to the guest device together with the RPC message.

According to another aspect of the present invention, when a first smart device (hereinafter referred to as a “host device”) executes a specific application, the platform of the second smart device (hereinafter referred to as a “guest device”). A method for performing the UI in the guest device by receiving a user interface (UI) from the host device by the operation of a program that performs a role (hereinafter referred to as a “guest platform”) is, (a) receiving, from a host device, a package file of an application selected according to a user's input (hereinafter, referred to as a “host app”); (b) receiving a UI object set from a host device; and (c) rendering the UI according to the UI object set received in step (b) and displaying it on the screen of the guest device.

In the case of receiving the entire screen including the UI object set in step (b), between steps (b) and (c), (b1) the user's selection of UI element set on the received screen may be further included, and the UI object set received in step (c) may be a UI object set for the selected UI element set in step ( )).

The information received in step (b) may further include information on whether the UI is being migrated or replicated to the guest device.

After the step (c), (d) from the host device, when a message of cross-device function calls (hereinafter referred to as “RPC (remote procedure call)”) is received, the message is for updating the UI state (hereinafter, the update of the UI state is referred to as “UI update”) displayed on the screen of the guest device, the step of performing a UI update on the UI of the guest device screen may be further included.

When the UI is replicated to the guest device, (e) when data by the user input through the UI of the guest device is received, transmitting the data to the host device.

The method for performing a user interface distributed from the host device includes (f) recognizing a local function call for executing a host app according to the data received in step (e). A step may be further included, and in this case, the called function may be suppressed to a RPC (remote procedure call).

After step (f), (g) receiving a return value of the function called in step (f), received from the host device, and proceeding to the next step of executing the called function may be further included. .

When the UI is replicated to the guest device, (h) when receiving user input from the host device, displaying it through a UI on a screen of the guest device may be further included.

A method for performing a user interface distributed from the host device includes: (i) recognizing a local function call for executing a host app according to the data received in step (h). A step may be further included, and in this case, the called function may be suppressed to a remote procedure call (RPC).

When the UI has been migrated to the guest device, it may further include the step of: (j1) receiving data by a user input through the UI of the guest device; (j2) when a function call for executing a host app is recognized according to the data in step (j1), it is intercepted and converted into a RPC (remote procedure call), and transmitting to the host device.

The step (j2) includes: (j21) when the function is called, a code conversion function is preset for replacement is called; (j22) converting the function into an RPC message by the code conversion function; and (j23) transmitting the RPC message to the host device.

After the step (f) or after the step (i), by receiving the return value of the function called in the step (f) or in the step (i), received from the host device, and then executing the called function, it may further include a step of proceeding to the step.

According to another aspect of the present invention, when executing a specific application, a first smart device that performs a function of distributing a user interface (UI) to a second smart device (hereinafter referred to as a “guest device”) The device (hereinafter referred to as a “host device”) includes at least one processor; and at least one memory for storing a computer-executable instruction, wherein the computer-executable instruction stored in the at least one memory is (a) located in a short distance to a guest device by the at least one processor. Displaying a list of devices that can be used and a list of applications (hereinafter referred to as “interaction applications”) that can interact using multiple UI screens with other devices on a host device screen; (b) transmitting a package file of an application selected according to a user's input to a selected device (hereinafter referred to as a “guest device”) according to a user input; and, (c) during operation of one of the applications (hereinafter referred to as “host app”) in the step (b), transmitting a UI object set used by the host app to the selected guest device in the step (b).

According to another aspect of the present invention, when a first smart device (hereinafter referred to as a “host device”) executes a specific application, a user interface (UI) is received from the host device, a second smart device (hereinafter referred to as a “guest device”) is to perform the UI, and includes at least one processor; and at least one memory for storing a computer-executable instruction, wherein the computer-executable instruction stored in the at least one memory is provided by the at least one processor, (a) receiving a package file of selected application (hereinafter referred to as “host app”) according to a user input; (b) receiving a UI object set from a host device; and (c) rendering the UI according to the UI object set received in step (b) and displaying it on the screen of the guest device.

According to another aspect of the present invention, when a first smart device (hereinafter referred to as a “host device”) executes a specific application, the second smart device (hereinafter referred to as a “guest device”) is used. A computer program (hereinafter referred to as a “host platform”) stored in a non-transitory storage medium operating on the host device in order to distribute a user interface (UI) is stored in a non-transitory storage medium, by a processor, includes instructions: (a) display on the host device screen a list of devices that are located in a short distance and can be used as guest devices, and applications that can interact using multiple UI screens with other devices (hereinafter referred to as “interaction applications”).; (b) transmitting a package file of an selected application according to a user's input to a selected device (hereinafter referred to as a “guest device”) according to a user's input; and, (c) during operation of one of the applications (hereinafter referred to as a “host app”) in the step (b), transmitting a UI object set used by the host app to the selected guest device in the step (b).

According to another aspect of the present invention, when a first smart device (hereinafter referred to as a “host device”) executes a specific application, a second smart device (hereinafter referred to as a “guest device”) receives a user interface (UI) from the host device. A computer program (hereinafter referred to as a “guest platform”) stored in a non-transitory storage medium (hereinafter referred to as a “guest platform”) that operates on the guest device to perform the UI in the is a non-transitory storage medium, by a processor, includes instructions: (a) receiving, from the host device, a package file of an selected application (hereinafter referred to as a “host app”) according to a user's input; (b) receiving a UI object set from the host device; and (c) rendering the UI according to the UI object set received in the step (b) and displaying it on the screen of the guest device.

According to the present invention, by separating a subtree including a target UI object set of a host device and transmitting it to an guest device, it is an effective method that the target UI object set can be rendered on an guest device, and also interactions between distributed devices are maintained without modifying the code of a app since local function calls between the distributed devices transparently are converted to RPC due to a interaction between UI object set and host app logic performed in the form of a local function call in a distributed device.

### BRIEF DESCRIPTION OF THE DRAWINGS

FIG. 1 illustrates a situation in which a user interface (UI) of a chat window for chatting with other viewers and a broadcast video screen overlap while a user is watching a live broadcast through a live streaming app on a mobile device.

FIG. 2 illustrates a situation in which a chat window UI is distributed to a guest device while a live broadcast is shown on a first device.

FIG. 3 is a diagram showing UI structure of an Android, which is an embodiment of a basic platform to which the present invention is applied.

FIG. 4 is a flow chart showing the overall process of performing the user interface distribution method according to one aspect of the present invention.

FIG. 5 is a diagram illustrating one possible UI distribution of a user interface distribution method according to the present invention.

FIG. 6 is a diagram further illustrating a UI interaction in the user interface distribution method according to the present invention.

FIG. 7 is a flow chart showing UI update during a UI migration process in a user interface distribution method according to another aspect of the present invention.

FIG. 8 is a flow chart showing a host app function call through a user's UI input during a UI migration process in a user interface distribution method according to another aspect of the present invention.

FIG. 9 is a diagram of a UI migration process in a user interface distribution method according to another aspect of the present invention.

FIG. 10 is a flow chart showing UI update during a UI replication process in a user interface distribution method according to another aspect of the present invention.

FIG. 11 is a flowchart illustrating a host app function call through a user's UI input during a UI replication process in a user interface distribution method according to another aspect of the present invention.

FIG. 12 is a diagram of a UI copy process in a user interface distribution method according to another aspect of the present invention.

FIG. 13 illustrates an embodiment of a method in which an app developer presets UI objects to be migrated or replicated according to another aspect of the present invention.

### DESCRIPTION OF EXEMPLARY EMBODIMENTS

Hereinafter, exemplary embodiments of the present invention will be described in detail with reference to the accompanying drawings. Terms or words used in this document are not intended to be construed as being limited to their usual or dictionary meanings. Rather, the terms and words herein should be construed as defined herein and in the context of the present invention and technology and with meanings and concepts consistent with the present invention and its technological area. Accordingly, the present invention is not limited to the embodiments described in the present specification and the configurations shown in the drawings and discussed herein.. It should be understood that there may be methods, devices, or systems having alternative embodiments or implementations, equivalents, and variations while falling within the scope of the present invention.

FIG. 2 is a diagram illustrating a situation in which a chat window UI is distributed to another device (guest device) by using a user interface distribution method according to the present invention.

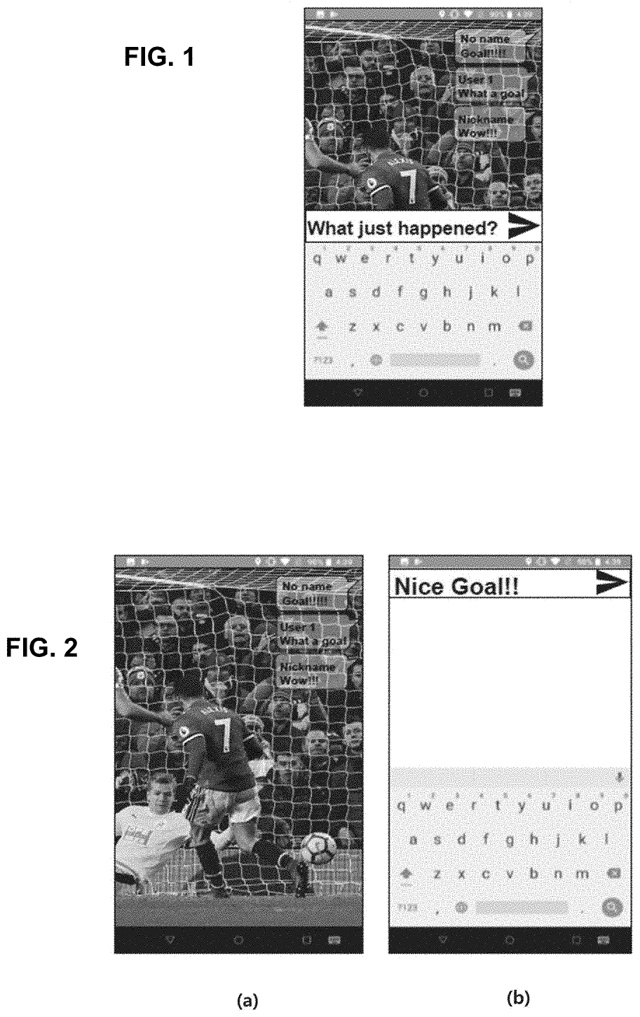

The present invention supports the user to move the chat window UI of FIG. 1 to a guest device as shown in FIG. 2(b), and allows the user to enjoy streaming in full screen on the original device as shown in FIG. 2(a), It can provide better usability. In addition to these embodiments, various useful embodiments can be made by flexibly arranging application UIs on various devices.

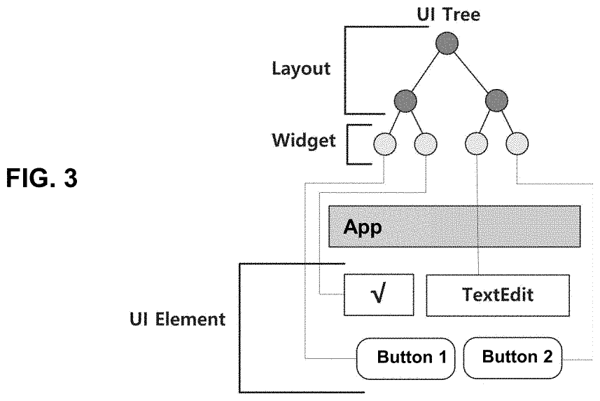

FIG. 3 is a diagram showing a UI structure of Android, which is an embodiment of a basic platform to which the present invention is applied.

UI is composed of a set of UI elements (hereinafter referred to as “UI elements”). The UI element means, for example, a text input window, each button, and the like as shown in FIG. 3. From the user's point of view, the UI element is the smallest unit through which the user can interact with the application.

Android, which is an embodiment of the basic platform to which the present invention is applied, has two types of UI objects, that is, a layout and a widget as shown in FIG. 3. These layouts and widgets are maintained in a tree structure called “UI tree”, and these UI objects include program code and data. The widget is a graphical component mapped one-to-one with each UI element (e.g., button) as shown in FIG. 3, and the layout is graphical data which manages how each UI object is positioned on the screen of the device.

Each UI object manages state data that fall into two categories of states: graphical states and non-graphical states. The graphical state refers to the data for rendering, such as color, text, picture, animation, etc., and the non-graphical state refers to all other data that are not related to rendering, and are mainly data related to application logic.

Hereinafter, such graphical state data will be referred to as “UI resources”. It was previously said that the UI object has a layout and a widget, and includes program code and data. When the program code and data are collectively referred to as data, such graphical state data, the UI resources and non-graphical state data are summed and expressed as a UI object. Each UI element is a term mainly representing each UI element appearing on a screen, and a UI object is a term mainly viewed from the viewpoint of program code and data, but hereinafter, it will be used without making a big distinction.

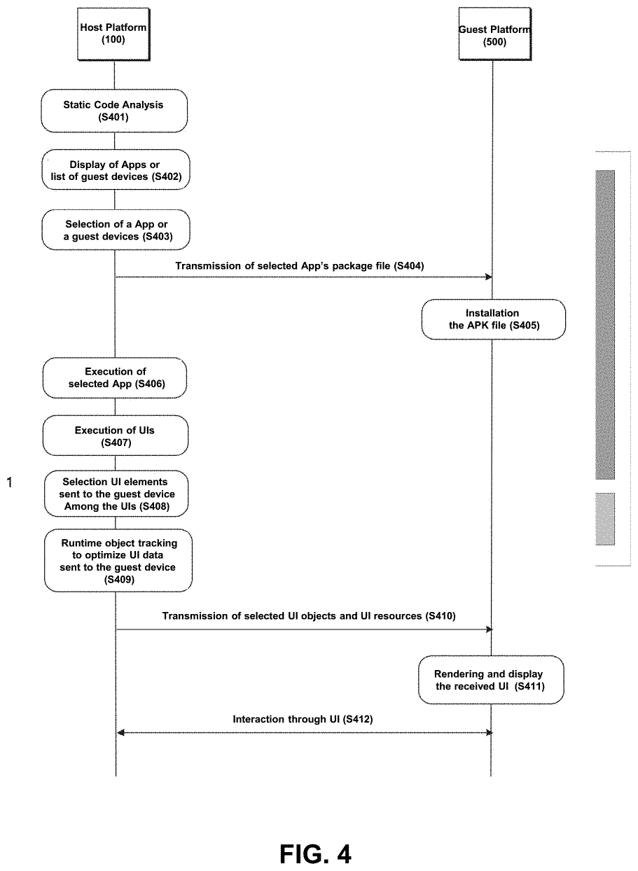

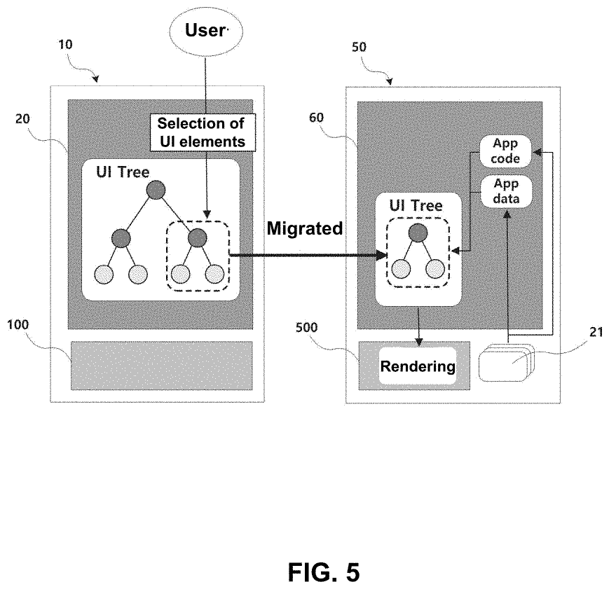

FIG. 4 is a flowchart showing an overall process of performing a user interface distribution method according to the present invention, and FIG. 5 is a schematic diagram for explaining UI distribution in the user interface distribution method according to the present invention.

In the present invention, even if the host device 10 and the guest device 50, use the same platform as a base platform, or use different base platforms, the app code is platform-independent. It can be applied in cases where it can be executed smoothly (for example, Web App, etc.). Here, the basic platform refers to a platform (eg, Android) that operates on each of the host device 10 and the guest device 50 before the host platform and the guest platform of the present invention described below are implemented.

The platform program (hereinafter referred to as a “host platform”) 100 for performing the user interface distribution method of the present invention in the host device 10, which is a smart device, includes a specific application program (hereinafter referred to as a “app”) is installed, the application code of the app is analyzed, and candidates of UI objects and UI resources used by the app are extracted and stored (S401). This is hereinafter referred to as a “static code analysis”.

That is, the input of the static code analysis process becomes the entire application code, and the output of the static code analysis process accordingly becomes the candidates of UI objects and UI resources used by the application. Examples of UI objects and candidates of UI resources may include an object having shape information of the corresponding UI, text, and color used for the corresponding UI. When a background image or a UI has moving dynamics, such UI animation information may be included.

The host platform 100 includes a list of devices that can be used as guest devices 50, which are other smart devices located in a short distance, and multiple UIs with other devices among apps installed in the host device 10 according to a user's request. A list of interaction apps (hereinafter referred to as “interaction apps”) using the screen is displayed on the screen of the host device 10 (S402).

The user selects a device (hereinafter, the selected device is referred to as a “guest device 50”) to interact with the UI (S403), and also selects an app to use the UI interaction (S403). The host platform 100 transmits the package file of the selected app (hereinafter referred to as a “app package file (APK)”) to the selected guest device 50 (S404), and the platform program (hereinafter referred to as a “guest platform 500”), performing the distribution method of the present invention from the guest device 50, receives the app package file and installs it on the guest device 50 (S405).

The user drives one app (hereinafter referred to as a “host app”) from the list of interaction apps mentioned in step S402 (S406), and drives one of the UIs used by the host app during the host app operation (S407). For example, during the operation of an app for broadcasting such as sports, a chat UI for chatting with other users may be driven.

During the operation of the host app, in the UI driven in this way, a user's input for selecting a UI element set to be sent to the guest device 50 is received (S408). For example, among UIs that are driven and displayed on the screen of the host device 10, a portion of UI element set can be selected and transmitted to the guest device 50, a schematic diagram of which is shown in FIG. 5.

When a user input for selecting a UI element set for sending to the guest device 50 is received (S408), the selected UI element set in step S408 from among the candidate group of UI objects and UI resources extracted in step S401 is sent to the guest device (S408). An UI object set (including UI resources and non-graphical state data) that is actually used in execution of the guest device 50 is extracted (S409), and this process is hereinafter referred to as a “runtime object tracking”. As described above, each UI element is a term that refers mainly to each UI element that appears on the screen, and UI object is a term mainly the point of view of program code and data, this is a concept term that includes all data, UI resources that are graphical data and non-graphical state data. Therefore, in the case of sending a UI to the guest device 50, the expression to send the “UI element” and the expression to send the “UI object” may be used in the same meaning, and hereafter mainly uses the expression of latter.

Meanwhile, when the host device 10 is a device in which it is difficult for the user to select a UI element set, such as a smart TV, the user of the guest device 50 may directly select a UI element set to be used. In this case, the host device 10 may perform mirroring in which the entire screen including the UI objects are transmitted to the guest device 50, and the user of the guest device 50 selects a UI element set to be used on the received screen.

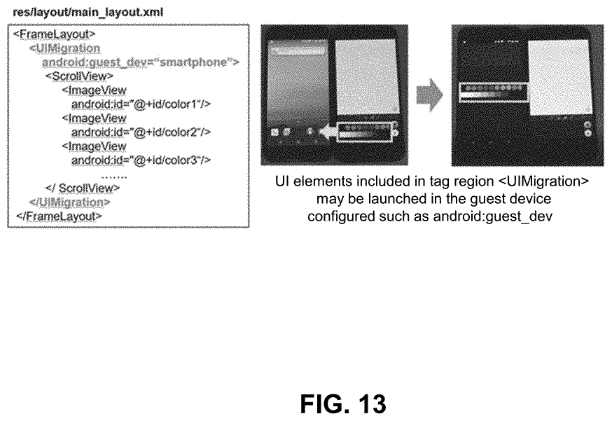

In another embodiment of transmitting the UI object set to the guest device 50, the UI object set for sending to the guest device 50 is determined by the app developer in advance, not by the user's selection (S408) as described above. There is a way that FIG. 13 shows an embodiment of a method in which an app developer presets UI objects to be moved or replicated.

That is, the app developer pre-stores the UI object set (including UI resources and non-graphical state data) to be transferred to the guest device 50 in a migration or replication method at runtime. It is specified (set) in the app layout file, which is metadata. Such app layout file may be written in an XML format, and is parsed when the app is operated, and UI objects corresponding the layout are configured and drawn on the screen.

In the present invention, new tags and properties are provided in the app layout file so that the app developer can specify the UI object to be transferred to the guest device 50 by migration or replication. That is, referring to FIG. 13, the app developer may pre-determine UI objects to be migrated/replicated by setting the <UIMigration> or <UIReplication> tag area. In addition, it is possible to set individual UI objects by adding a new XML property such as android: UI_migration=“true”.

Alternatively, a UI object set to be transferred to the guest device 50 in a migration or replication method at runtime is created by the host platform developer and stored in the host device 10, not by the app layout file. It can also be specified (set) in the platform layout file. The method of setting the UI object set in the platform layout file is the same as the method of setting it in the above-described app layout file.

Accordingly, the host platform can automatically select which UI objects to transfer to which guest devices by parsing newly added tags and properties without user intervention. That is, the app user of the host device 10 simply selects to deliver a UI set to a guest device after running the app, and the host platform transfers the UI object set of the corresponding UI set in the app layout file or the platform layout file. It is transmitted to the device 50.

Meanwhile, when a UI element set is selected by a user and a UI object set for the selected UI element set is delivered to the guest device 50, the host platform 100 saves the selected UI element set to the platform layout file of the host platform 100. In this way, afterwards, the host platform can transmit the UI object set for the UI element set stored in the platform layout file to the guest device 50 without the need for selection by the user.

The host platform 100 transmits the selected UI object set and its UI resource set to the guest device 50 (S410), and the guest platform 500 renders the UI set according to the UI object set for the UI element set received in step S410. It is displayed on the screen of the guest device 50 by rendering (S411). In step S410, the information transmitted to the selected guest device 50 may further include information on whether to migrate or replicate the selected UI set by the user to the guest device 50.

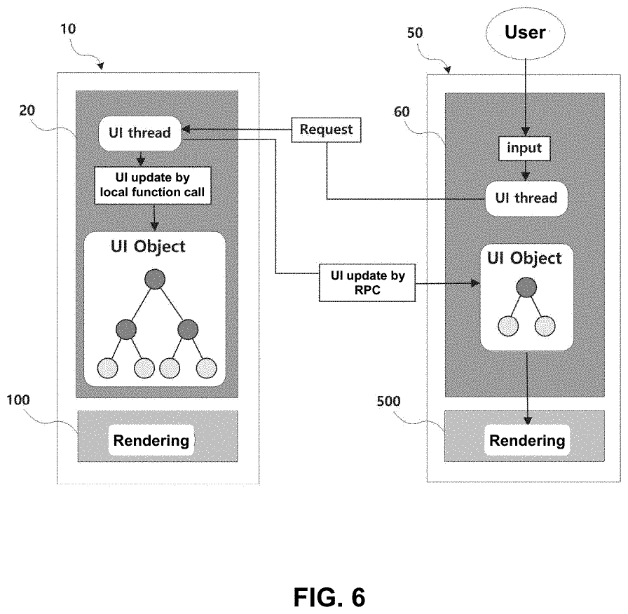

Thereafter, an interaction between the host device 10 and the guest device 50 occurs through the UI, which will be described later with reference to FIGS. 6 to 12.

FIG. 6 is a schematic diagram for explaining UI interaction in the user interface distribution method according to the present invention.

The “UI thread” shown in FIG. 6 refers to a function of handling the UI tree and updating the state of the UI object of each app. For example, when a user clicks a button, the UI thread executes an event handler related to a button click.

As soon as the UI is displayed on the screen of the guest device 50, the host platform and the guest platform allow the user to interact with the host app as if the UI was on the same device through the host and guest UI.

For example, the user may swipe a video progress bar on the screen of the guest device 50 to determine which part of the video clip to display on the host device 10. The host platform and the guest platform enable this interaction, which is accomplished by converting local function calls into cross-device function calls, if necessary.

Referring to FIG. 6, when the UI state is updated on the guest device screen by a user's input on the guest device screen, the guest platform 500 transmits the received user input data, to the host app 20 of the host device 10, by the UI thread of a wrapper app 60 of the guest device 50. Once host app 20 calls a local function for UI update, the host platform 100 intercepts the call and converts it into a cross-device function call and sends it to the guest device 50, and the guest platform 500 performs a UI update by converting the cross-device call back to a local function call.

While the host app 20 used in the host device 10 operates as it is without modification of the code, this method is performed by intercepting a local function call by an operation of the host platform 100, and converting the local function call into a cross-device function call, and sent it to the guest device 50 so that the UI can be provided in another device. Without modifying the code of the existing host app 20 that has only a local function call for UI update within the same device, cross-device function calls are made by the operation of host platform 100 while the host app 20 does not recognize it at all.

The guest platform 500 as well, in the guest device 50, intercepts cross-device function calls received from the host device 10 and convert the calls into local function calls, and UI processing is naturally performed on the guest device 50 as well.

In the above-described method, a local function call of the guest device 50 is converted into a cross-device function call to the host device, and such cross-device function calls applied to same process on the host device.

As such, a concrete implementation method of cross-device function calls made by the interception operation of the host platform 100 and the guest platform 500 without modifying the existing app that is intended to use the UI in the device. As an embodiment, a code conversion function method may be used, which will be described later.

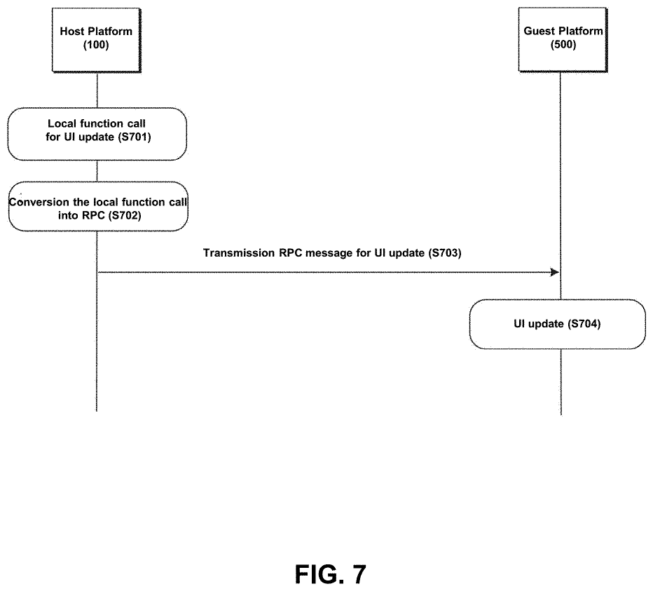

Such UI interactions are classified into UI migration and UI replication, and will be described later with reference to FIGS. 7 to 9 and 10 to 12, respectively.

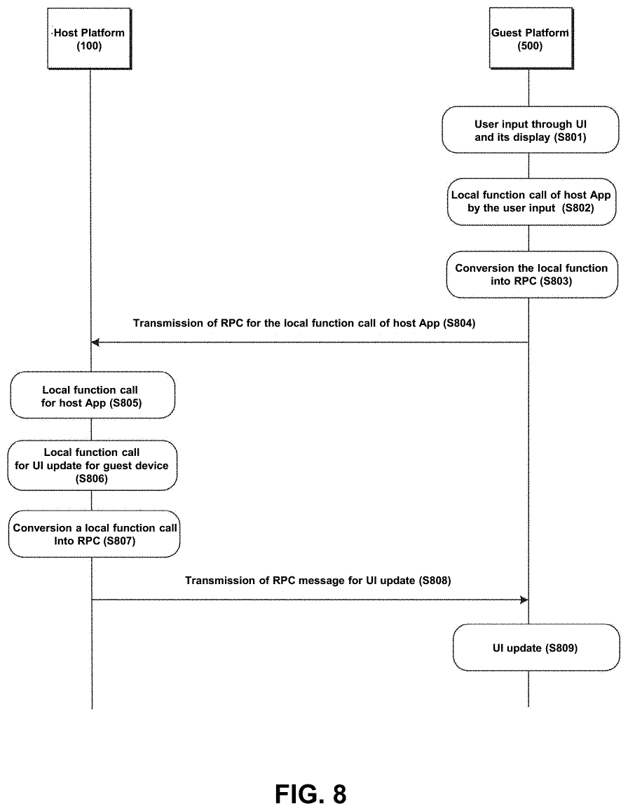

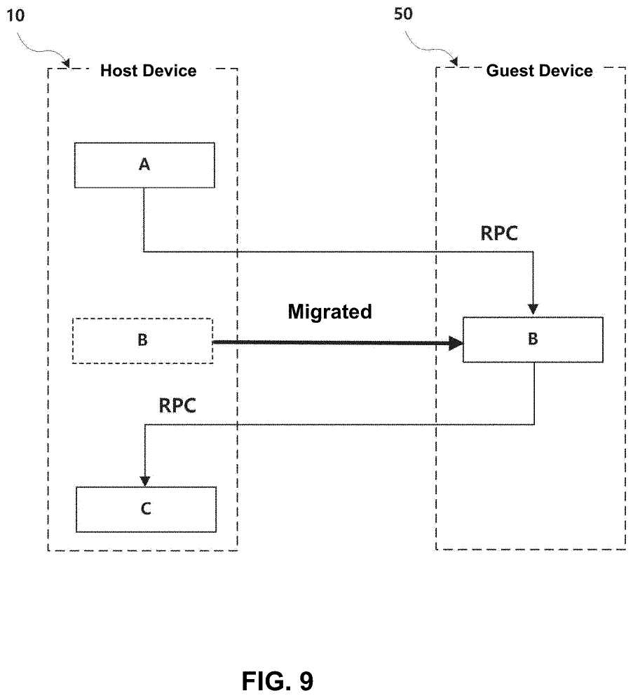

FIG. 7 is a flow chart showing UI update during a UI migration process in the user interface distribution method according to the present invention. FIG. 8 is a user interface distribution method in the UI migration process according to the present invention, and a flow chart showing a host app function call through UI input. FIG. 9 is a schematic diagram of a UI migration process in the user interface distribution method according to the present invention.

As described above, the information, transmitted to the selected guest device 50 in step S410 of FIG. 4, may further include that the selected UI set by the user is transferred to the guest device 50, or whether the selected UI set by the user is to be migrated or replicated. FIGS. 7 to 9 are processes when migration is selected.

First, FIG. 7 is a flow chart showing a UI update in general among the UI migration process, and FIG. 9 mainly shows a process of A-->B.

The update of the UI state displayed on the screen of the guest device 50 (hereinafter referred to as an “UI update”) is performed by a local function call of the host app (S701).

The UI update is, for example, during broadcast streaming through the host app, the video progress bar continues to progress, this video progress bar is also a kind of UI, and the UI state is constantly changing, and UI update is taking place. This UI update is necessarily performed by calling the host app's function. In this case, the UI update occurs by calling a function of the host app according to the execution of the host app without a user's input through the UI in the guest device 50. Step S701 of FIG. 7 shows such a case.

Alternatively, when a user input through the UI is received on the screen of the guest device, the UI may be updated in the guest device by transmitting it to the host device 10 and calling a function by the host app accordingly. For example, when a user inputs a specific button on the guest device, there may be a case where the color of the UI on the screen of the guest device changes. Such a case is shown in FIG. 8, and will be described later in detail with reference to FIG. 8.

The host platform 100 converts such a local function call of the host app into a cross-device function call, a remote procedure call (RPC) message (S702), and transmitted to the guest device 50 (S703). This means the RPC indicated such as A->B in FIG. 9. In the present invention, the host platform 100 intercepts a local function call from an app on the host device 10 and the app does not recognize cross-device function calls to the guest device 50, or a local function call from an app on the guest device 50 (precisely, a wrapper app 60) is intercepted by to the guest platform 500 and the call is converted into cross-device function call and sent to the host device 10 while the app does not recognize above procedures. RPC (remote procedure call) is used as a term for cross-device function calls in this invention.

To describe these processes (S701 to S703) in more detail, when the host app's local function call for updating the UI state (hereinafter referred to as “UI update”) displayed on the screen of the guest device 50 (S701), the code conversion function is set in advance to replace the local function call is called by the host app (S701) and converts the local function call into an RPC message (S702), and the RPC message is transferred to the guest device 50 (S703). Such a code conversion function is set in the host platform 100 or the guest platform 500, and thereafter, the operation performed by the code conversion function is described such as operation performed by the host platform 100 or the guest platform 500.

At this time, when the argument of the RPC message is a device-dependent factor, the data value, a reference type argument, indicated by the reference type factor together with the RPC message is sent to the guest device 50 together with the RPC message.

In this way, when the guest platform 500 receives an RPC (remote procedure call) message for updating the UI status (hereinafter referred to as “UI update”) displayed on the screen of the guest device 50 from the host device 10 (S703), the guest platform 500 converts the RPC message back to a local function call in the guest device to update the corresponding UI (S704). After sending the RPC message in this way, the host platform 100 stores the return address to be returned after performing the RPC call, and when it receives the return value or error code for the RPC call from the guest device 50, it returns to the return address, and takes the next step.

Next, FIG. 8 is a flow chart showing a host app function call through a user's UI input among UI migration processes, and FIG. 9 mainly shows a process B-->C.

In response to the user's input through the UI (S801), when recognizing the local function call (S802) for executing the host app, the guest platform 500 converts the call to a RPC (remote procedure call) (S803) transmitted to the host device 10 (S804), and the host platform 100 receives and converts the RPC message back to a local function call in the host device to make a corresponding host app function call (S805). For example, when the user presses a toggle button for play-pause on the guest device, there may be a situation in which the streaming app screen changes to stop-play on the host device.

To describe the processes (S801 to S805) in more detail, when a local function call of the host app according to a user input (S802), a code conversion function set in advance to replace the local function call is called by the guest app (S802) and converts the call into an RPC message (S803), and the RPC message is transmitted to the host device 10 (S804).

If the UI needs to be updated in the guest device according to the user's input in step S801, a local function call (S806) for UI update occurs on the guest device 50 according to a local function call of host app by operation of host app logic in step S805 of FIG. 8. Accordingly, the host platform 100 converts the local function call to a RPC (remote procedure call) (S807) and transmits the RPC message to the guest device 50 (S808), and in the guest device 50, the guest platform 500 performs UI update (S809). This process of steps from S806 to S809 is not shown in FIG. 9.

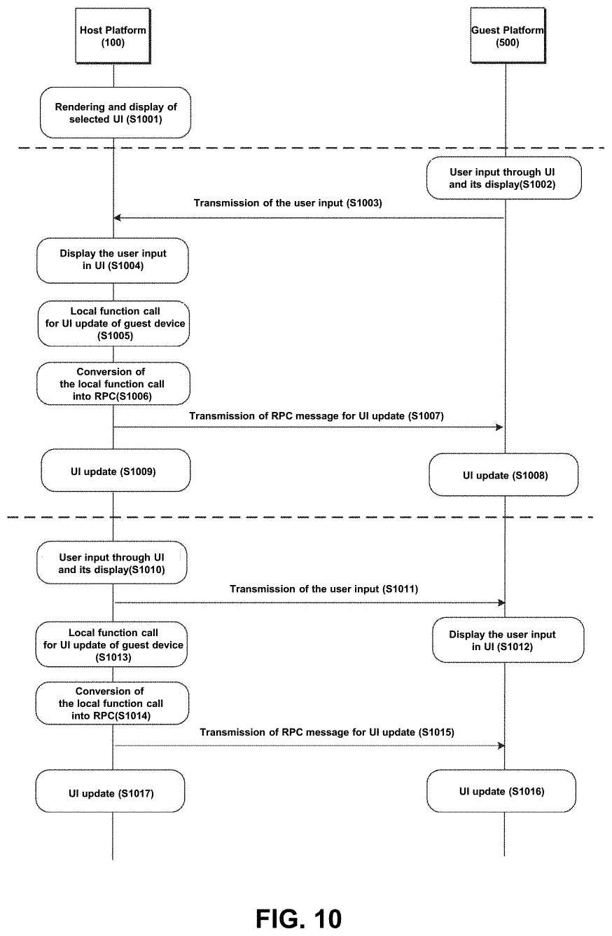

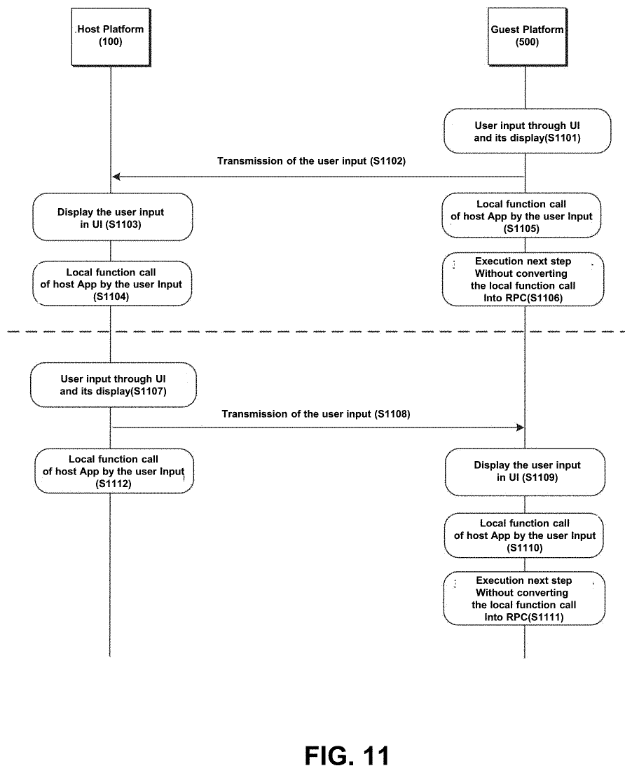

FIG. 10 is a flow chart showing UI update during a UI replication process in the user interface distribution method according to the present invention. FIG. 11 is a UI replication process in the user interface distribution method according to the present invention. It is a flow chart showing the host app function call through UI input. 12 is a schematic diagram of a UI replication process in a method for distributing a user interface according to the present invention.

As described above, Information, transmitted to the selected guest device 50 in step S410 of FIG. 4, further include that the selected UI by the user is transferred to the guest device 50, or whether the UI selected by the user is to be migrated or replicated. FIGS. 10 to 12 are processes in the case of replication selected.

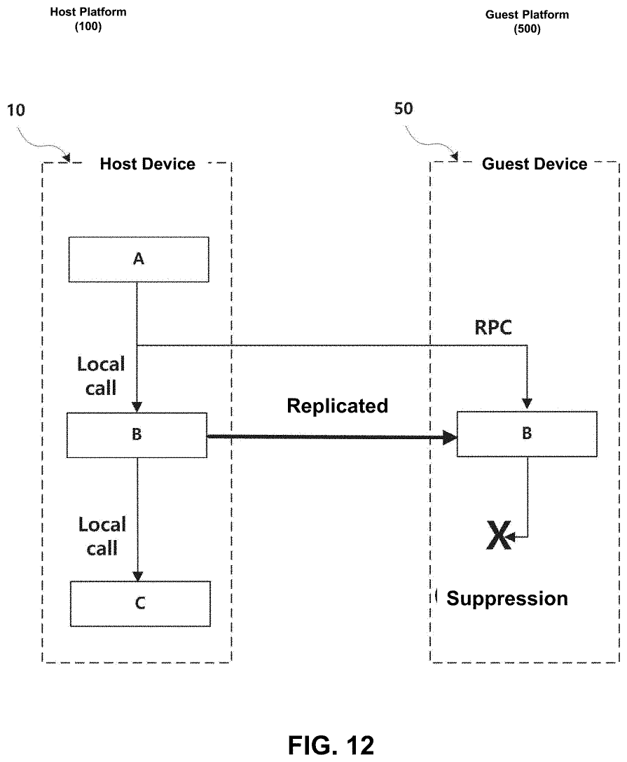

First, FIG. 10 is a flow chart showing UI update among the UI replication process, and FIG. 12 mainly shows a process of A-->B.

The UI update by user input through the UI, unlike the case of UI migration, may occur not only by the guest device 50 but also by a user input from the host device 10, and steps S1002 to S1009 of FIG. 10 represent UI updates generated by a user input through the guest device 50 UI, and steps S1010 to S1017 of FIG. 10 represent UI updates generated by a user input through the host device 10 UI. But for convenience, only UI updates processes generated by a user input through the host device 10, A-->B (Local Call, RPC) is illustrated in FIG. 12.

Referring to FIG. 10, when replication selected, the host platform 100 transmits the same UI as the UI object set and UI resource set of the UI element set selected by the user to the guest device in step S410 of FIG. 4. With the data, the UI is rendered and displayed on the screen of the host device (S1001). That is, the same UI as on the screen of the guest device 50 is also displayed on the screen of the host device 10.

Thereafter, the guest platform 500 continuously transmits the data input by the user (S1002) through UI of the guest device 50 (S1003), and the host device 10 receives and display the data on the screen (S1004). That is, the user's input data is also displayed on the input guest device 50 (S1002) and at the same time also displayed on the screen of the host device 10 (S1004).

Thereafter, when a local function call of the host app for UI update on the screen of the host device 10 and for UI update on the screen of the guest device 50 is called (S1005), the host platform 100 performs the UI update by the called function in the host device 10 (S1009), and the host platform 100 converts the same function call into RPC (a remote procedure call) message (S1006) and transmits it to the guest device 50 (S1007). Accordingly, the same UI update is performed in the guest device 50 (S1008).

As described above, when an argument included in the RPC message is a reference type such as a device-dependent argument, the data value indicated by the reference type argument together with the RPC message is sent to the guest device 50.

After step S1010, a case in which the user inputs data through the host device 10 is indicated. The host platform 100 continuously transmits data by the user input through UI (S1010) of the host device 10 to the guest device 50 (S1011), and the guest device 50 receives and displays the data on the screen of guest device 50 (S1012). That is, the user's input data is also displayed on the input host device 10 (S1010) and at the same time also displayed on the screen of the guest device 50 (S1012). In this case, the transmission of the inputted data (S1010) to the guest device 50 (S1011) may be performed by an RPC message, and the display of such data on the screen of the guest device 50 (S1012) is done by an UI update.

However, even in this case, without the steps (S1010, S1011) according to the user's input through the UI in the host device 50, UI update may occur by calling a function of the host app (S1013) according to the execution of the host app. have. This is similar to step S701 of FIG. 7 of UI migration.

Thereafter, when a local function call of the host app (S1013) to update the UI on the screen of the host device 10 and the screen of the guest device 50 (S1013), the host platform 100 performs, by the called function, the UI update in the host device 10 (S1017), and converts the same function call into a remote procedure call (RPC) message (S1014) and transmits it to the guest device 50 (S1015), whereby the same UI update is performed in the guest device 50 (S1016).

When the above-described steps S1005 to S1007 and S1013 to S1015 are described in more detail, when a function is called by the host app (S1005 and S1013), a code conversion function set in advance to replace the function is called, and calls the function in the host device 10 (S1009, S1017), and converted the function call into an RPC message (S1006, S1014), and the RPC The message is transmitted to the guest device 50 (S1007 and S1015).

Next, FIG. 11 is a flow chart showing a host app function call through a user's UI input among the UI replication process, and FIG. 12 shows a process of B-->C (local call, suppression).

The host app function call by user input through the UI, unlike the case of UI migration, may occur not only by the guest device 50 but also by the user input from the host device 10, and the step of FIGS. 11 S1101 to S1104 represent host app function calls generated by a user input through UI of the guest device 50, and steps S1107, S1108, and S1112 of FIG. 11 shows a host app function call (B-->C, Local call) corresponding to a user input through UI of the host device 10.

Referring to FIG. 11, the guest platform 500 continuously transmits data input by the user input through the guest device 50 UI (S1101) to the host device 10 (S1102), and the host device 10 receives it and displays it on the screen of the host device 10 (S1103). That is, the user's input data is also displayed on the input guest device 50 (S1101) and at the same time also displayed on the screen of the host device 10 (S1103). Thereafter, the host device 10 performs a host app function call (local call, see FIG. 12) (S1104, B->C, see FIG. 12).

Similarly, the host platform 100 continuously transmits data input by the user through UI of the host device 50 (S1107) to the guest device 10 (S1108), and the guest device 10 receives and display it on the screen of the guest device 10 (S1109). That is, the user's input data is also displayed on the host device 50 (S1107) and at the same time also displayed on the screen of the guest device 50 (S1109). In this case, transmission of the input data (S1107) to the guest device 50 (S1108) may be performed by an RPC message, and the display of such data on the screen of the guest device 50 (S1109) is performed in a UI update. Thereafter, the host device 10 performs a host app function call (local call, see FIG. 12) (S1112, B-->C, see FIG. 12).

However, in this case, when the guest platform 500 recognizes a local function call for executing the host app according to the user's input through UI of the host device 10 or the guest device 50 UI (S1105, S1110), this is not converted to RPC (a remote procedure call) (suppression, see FIG. 12) (S1106, S1111). This is different from the case of UI migration of FIGS. 7 to 9. The reason for this is as follows.

For example, if the user presses the play-pause toggle button through the UI of the host device 10 or the guest device 50, this input is transmitted not only to the UI of the guest device 50, but also to the UI of the host device, whereby the host device performs screen play->pause by the host app. If a RPC message is transferred to the host device 10 by a function call from the guest device 50, the corresponding function of the host app is called again and causes an error such as pause->play is performed again. To prevent this, it occurs conversion suppression of RPC message (S1106, S1111).

The guest device 50 receives the return value of the function called in steps S1105 and S1110, received from the host device 10, and proceeds to the next step of executing the called function (S1106, S1111).

Although the methods and devices have been described above on the basis of various diagrams, figures, flowcharts using a series of the steps or blocks, the present invention is not limited to the exact sequence of the steps, and some of the steps may be performed at different sequences from other steps or may be performed simultaneously with other steps. Furthermore, those skilled in the art will understand that the steps shown in the flowcharts are not exclusive and may include other steps or one or more steps of the flowcharts may be deleted without affecting the scope of the present invention.

What is claimed is:

1. A method of operating a device, the method comprising:
transmitting an application package to a guest device, the application package defining a plurality of UI elements wherein the plurality of UI elements related to each other in an original layout, and each UI element associated with UI resources;
transmitting a first set of UI elements to the guest device, the first set of UI elements identifying selected UI elements from the plurality of UI elements;
storing the first set of UI elements in a layout file;
transmitting a set of UI objects to the guest device, the set of UI objects associated with the first set of UI elements;
receiving remote a procedure call (RPC) signal from the guest device, the RPC signal relating to UI resources associated with the first set of UI elements; and
executing a local function corresponding to the received RPC signal.

2. The method recited in claim 1, wherein the original layout defines an original hierarchical UI tree and the first set of UI elements identifies UI elements that form a UI subtree of the original hierarchical UI tree.

3. The method recited in claim 1 further comprising a step of static code analysis analyzing the application package to identify candidates of the plurality of UI elements for UI distribution and updates.

4. The method recited in claim 1 further comprising a step of runtime object tracking to determine the set of UI objects associated with the first set of UI elements for UI distribution and updates.

5. The method recited in claim 1 further comprising a step of determining whether the first set of UI elements is migrated to the guest device.

6. The method recited in claim 1 further comprising a step of determining whether the first set of UI elements is replicated to the guest device.

7. The method recited in claim 5 further comprising a step of intercepting, when the first set of UI elements is migrated to the guest device, local function calls for UI updates associated with the first set of UI elements, and generating an RPC signal to the guest device.

8. The method recited in claim 6 further comprising a step of suppressing, when the first set of UI elements is replicated to the guest device, generation of an RPC signal to the guest device corresponding to the received RPC signal.

9. A device comprising:
at least one processor; and
memory storing instructions that, when executed by the at least one processor, cause the device to:
transmit an application package to a guest device, the application package defining a plurality of UI elements wherein the plurality of UI elements related to each other in an original layout, and each UI element associated with UI resources;
transmit a first set of UI elements to the guest device, the first set of UI elements identifying selected UI elements from the plurality of UI elements;
store the first set of UI elements in a layout file;
transmit a set of UI objects to the guest device, the set of UI objects associated with the first set of UI elements;
receive remote a procedure call (RPC) signal from the guest device, the RPC signal relating to the set of UI objects associated with the first set of UI elements; and
execute a local function corresponding to the received RPC signal.

10. The device recited in claim 9 wherein the original layout defines an original hierarchical UI tree and the first set of UI elements identifies UI elements that form a UI subtree of the original hierarchical UI tree.

11. The device recited in claim 9 wherein said memory storing instructions that, when executed by the at least one processor, cause the device to perform static code analysis of the application package] to identify candidates of the plurality of UI elements for UI distribution and updates.

12. The device recited in claim 9 wherein said memory storing instructions that, when executed by the at least one processor, cause the device to perform a runtime object tracking to determine the set of UI objects associate with the first set of UI elements for UI distribution and updates.

13. The device recited in claim 9 wherein said memory storing instructions that, when executed by the at least one processor, cause the device to determine whether the first set of UI elements is migrated to the guest device.

14. The device recited in claim 9 wherein said memory storing instructions that, when executed by the at least one processor, cause the device determine whether the first set of UI elements is replicated to the guest device.

16. The device recited in claim 13 wherein said memory storing instructions that, when executed by the at least one processor, cause the device to intercepting, when the first set of UI elements is migrated to the guest device, a local function calls for UI updates associated with the first set of UI elements, and generating an RPC signal to the guest device.

16. The device recited in claim 13 wherein said memory storing instructions that, when executed by the at least one processor, cause the device to suppressing, when the first set of UI elements is replicated to the guest device, generation of a RPC signal to the guest device corresponding to the received RPC signal.
